(19) United States
(12) Patent Application Publication
(10) Pub. No.: US 2006/0027289 A1
(43) Pub. Date: Feb. 9, 2006

(54) Angle adjustable sawing table

(76) Inventor: Kun-Meng Lin, Changhua Hsien (TW)

Correspondence Address: RABIN & BERDO, P.C., Suite 500, 1101 14th Street, N.W., Washington, DC, 20005, US

(21) Appl. No.: 10/912,217

(22) Filed: Aug. 6, 2004

(51) Int. Cl. B25H 1/00; B23D 19/00; B23D 33/02; B26D 1/14

(52) U.S. Cl. 144/286.1; 83/471

(57) ABSTRACT

An angle adjustable sawing table allowing interchange of displacement among measurement members on the table to compromise the installation of the circular saw; the wood material being place at pre-set geometric angle; one end of the gage being placed on the table, and another of the gage flushed against the measurement member for adjustment to meet the present angle for easier cutting and time-saving.

### BACKGROUND OF THE INVENTION

(a) Field of the Invention

The present invention is related to an angle adjustable sawing table, and more particularly, to one that allows direct measurement of geometric angles of wood materials for cutting.

(b) Description of the Prior Art

A sawing table on site is perhaps the most important tool in any decoration job for a carpenter. Usually the table has a foundation comprised of four pieces of boards including two girders and two stretchers with a table inserted on the top and a circular saw below the table.

In the prior art, the board is placed on the table and measured by manual for the geometric angle and the finished size to be cut; then marked when the angle is solved for the circular saw to cut the board into the size and angle desired. However, in the absence of any measurement tools designed to the sawing table, all the measurement and geometric angle must be done manually resulting in wasting of time, and poor accuracy and efficiency.

### SUMMARY OF THE INVENTION

The primary purpose of the present invention is to provide a sawing table that saves the efforts of manual measurement. To achieve the purpose, the present invention is adapted with control and measurement units and allowing adjustment of angle. The control unit facilitates the installation of a circular saw depending on the size of the circular saw, the thickness and the width of the board. A turning arm of the measurement unit is turned to the location preset for the cutting angle, and the board is placed on the table and flushed against the turning arm, the circular saw traveling on the rectangular rail isled to cut.

### BRIEF DESCRIPTION OF THE DRAWINGS

FIG. 1A is a perspective view showing an assembly of a saw table of the present invention.

FIG. 1B is an exploded view of the present invention.

FIG. 1C is a schematic view showing the bottom of a top of the saw table of the present invention.

FIG. 2A is a perspective view showing the appearance of a connection block of a control unit of the present invention.

FIG. 2B is a section view of the connection block of the control unit of the present invention.

FIG. 3A is a schematic view showing the guide rail facing up of the control unit.

FIG. 3B is a schematic view showing the guide rail facing down of the control unit.

FIGS. 4A, 4B, 4C, 4D, 4E, and 4F are side sectional views showing the adjustment of thickness and width of the control unit of the present invention.

FIGS. 4G, 4H, and 4I are front sectional views showing the adjustment of thickness and width of the control unit of the present invention.

FIGS. 5A and 5B are schematic views showing the layout of the control unit before the measurement of the angle by a square.

FIG. 6A is a schematic view showing the angle measurement by the square.

FIGS. 6B and 6C are schematic views showing the adjustment of the turning arm to cut on the saw table after the measurement of the angle by the square.

FIG. 7A is a schematic view showing the measurement of another angle by the square.

FIG. 7B is a schematic view showing the adjustment of the turning arm to cut on the saw table after the measurement of the angle by the square.

FIG. 8 is a schematic view showing that a circular saw is cutting a board.

FIG. 9 is a schematic view showing another gear set is adapted to where beneath the saw table of the present invention.

### DETAILED DESCRIPTION OF THE PREFERRED EMBODIMENTS

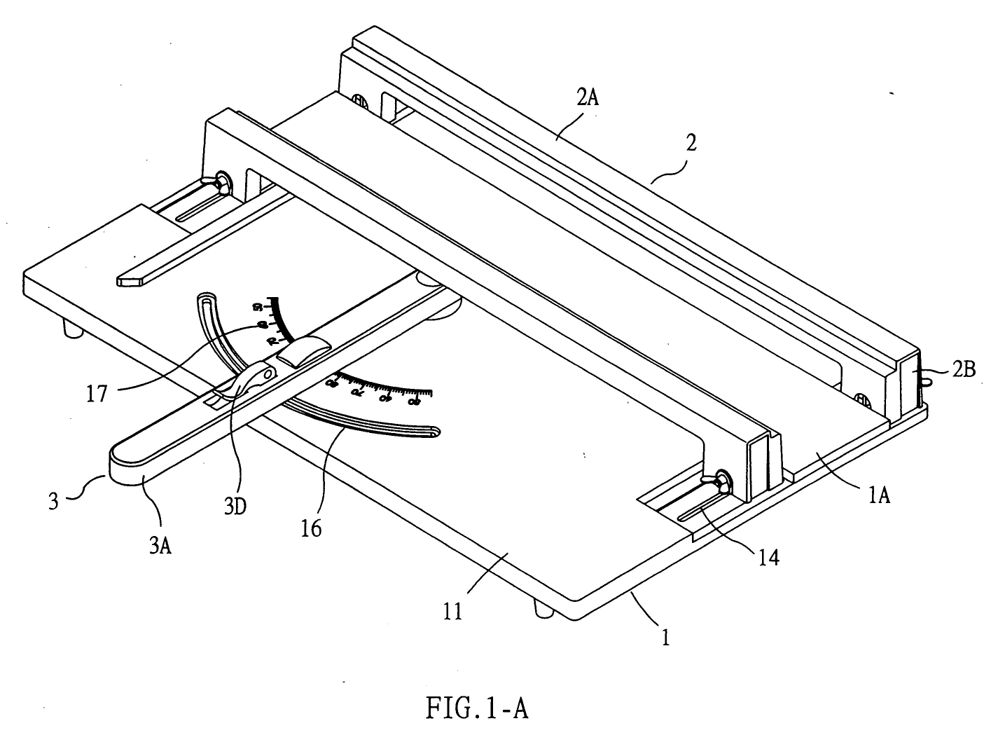

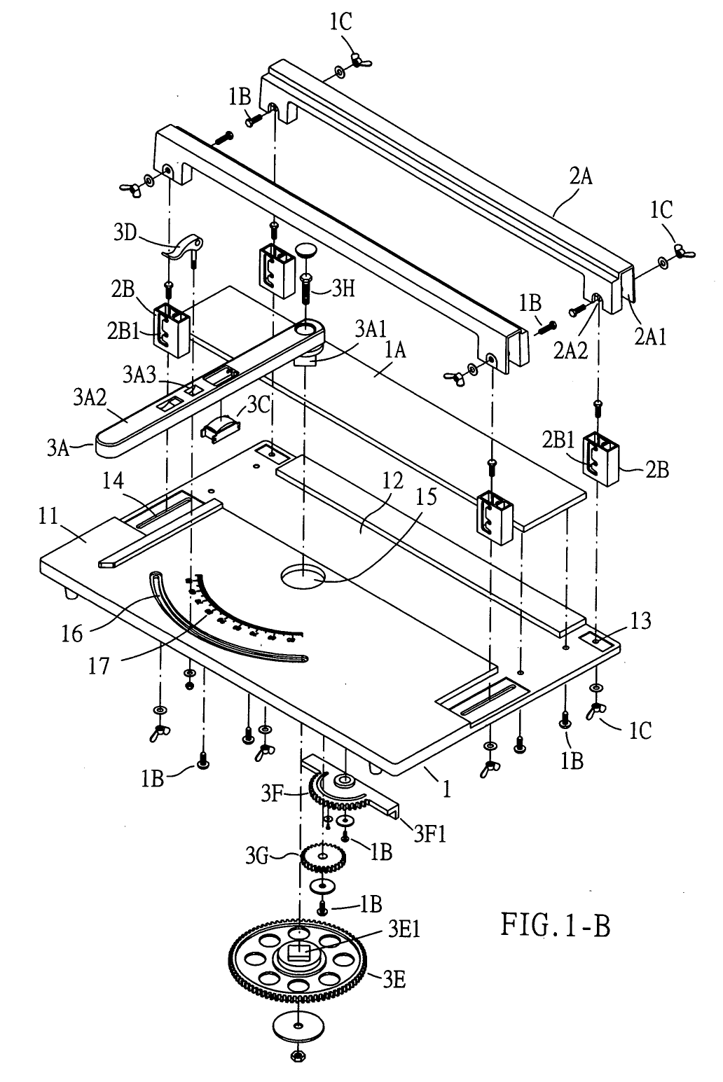

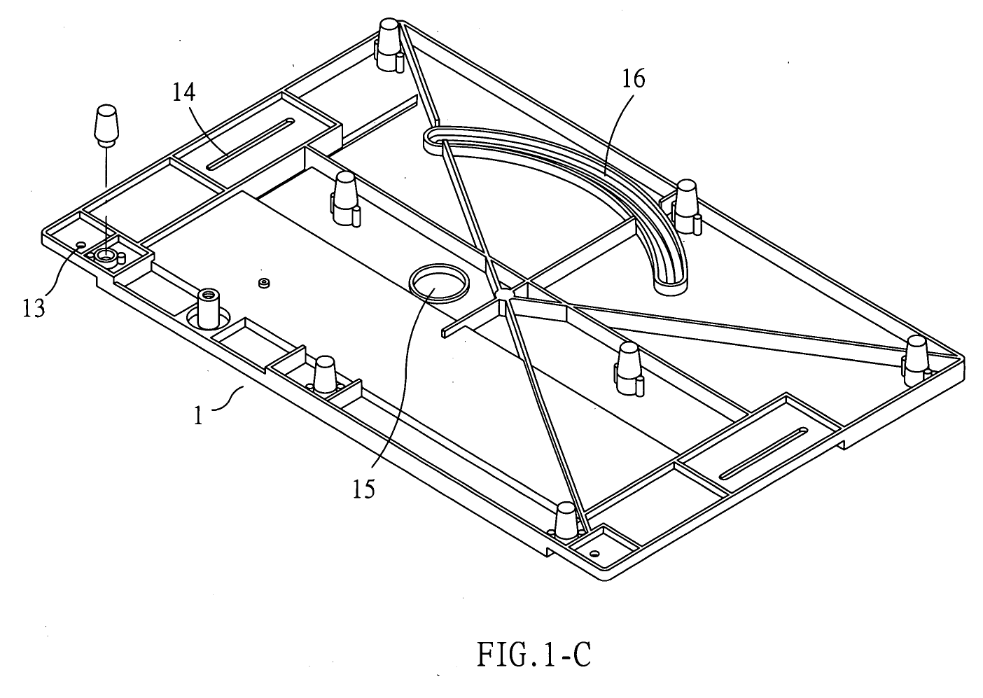

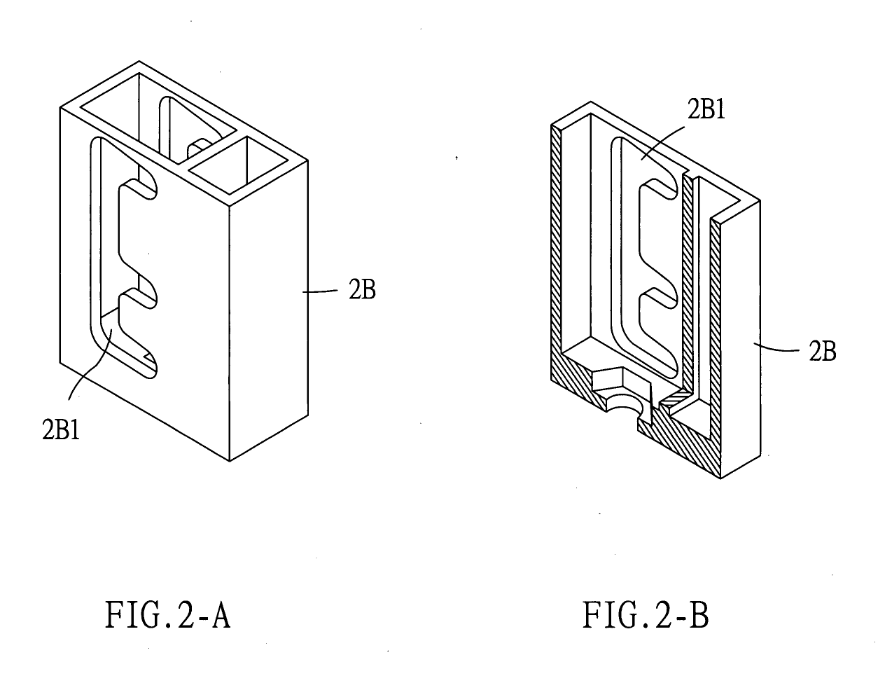

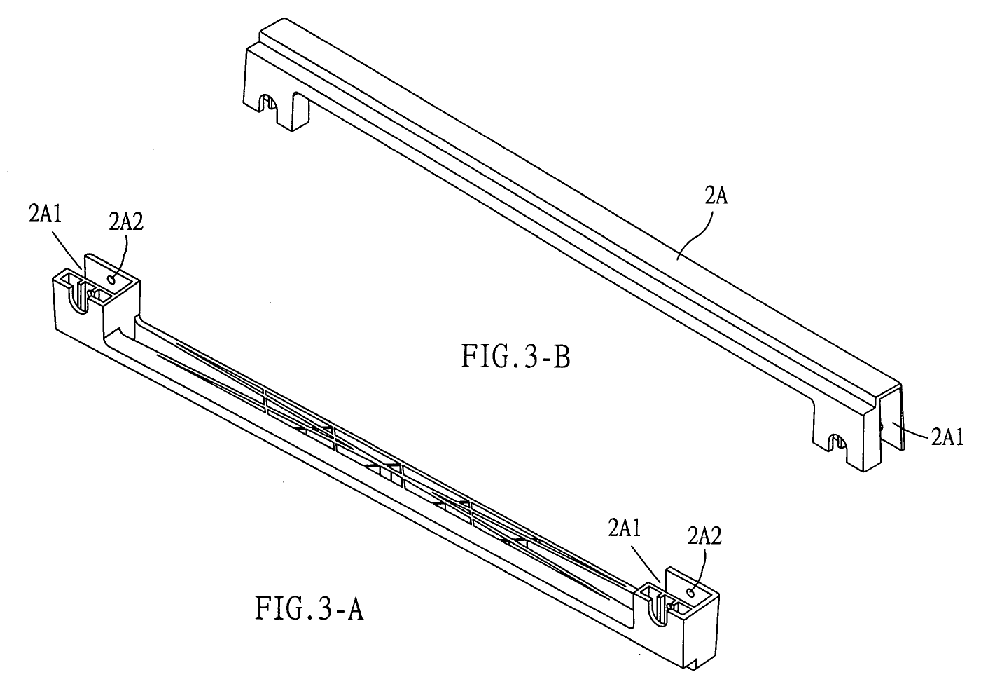

Referring to FIGS. 1A, 1B, 1C, 2A, 2B, 3A and 3B, the present invention is essentially comprised of a table 1, a top 11, a control unit 2 and a measurement unit 3.

The table 11 is provided on one side a longitudinally recessed guide trough 12 to be inserted with a plank 1A in the same size of the guide trough 12, and the plank 1A is secured to the table 11 with multiple screws 1B penetrating from beneath the top 11. As a circular saw 4 is processing on a board 4A, it cuts farthest into the plank 1A without damaging the top 11. Besides, the plank 1A is a consumption item and replaced at any time when worn and out to a certain extent. Each side of both shorter sides of the guide trough 12 is provided with a positioning hole 13 and a guide rail slot 14 for the assembly and positioning of two pairs of connection blocks 2B from the control unit 2. An axial hole 15 penetrating through the table 11 on one side of the guide trough 12 where the guide rail slot 14 is provided.

The control unit 2 comprised of a pair of guide rails 2A and two pairs of the connection blocks 2B is provided on the top 11 at the same side where the guide trough 12 is located. One pair of the connection blocks 2B is raised and locked to the positioning holes 13 disposed at both ends on one side of the table 11 using two screws 1B and two winged nuts 1C. Similarly, another pair of the connection blocks 2B is raised and locked to the guide rail slot 14 on the inner side of the table 11 with two screws 1B and two winged nuts 1C. The pair of the connection blocks 2B on the guide rail slot 14 is readily free to reciprocally travel thereon by loosening the winged-nuts 1C. The pair of guide rail 2A is provided striding over the plank 1A by means of those two pairs of the connection blocks 2B erected on the top 11. A chamber 2A1 defined in each end of the pair of the guide rails 2A merely accommodates its respective connection block 2B. A screw hole 2A2 is each provided on both sides of the chamber 2A1, and a multi-sectional adjustment channel 2B1 hollowed in “E” shape is each provided on both sides of the connection block 2B for the screw 1B and the winged-nut 1C to lock each connection block to the guide rail 2A. Accordingly, the pair of the guide rails 2A is integrated with both pairs of the connection blocks 2B.

The measurement unit 3 is comprised of a turning arm 3A and a gear set. A shaft 3A1 extends from the bottom of the fixed end of the turning arm 3A and passes downward through an axial hole 15 on the top 11 to be pivoted to the gear set disposed beneath the top 11. A square hole 3A3 and a magnifier 3C are provided on the surface 3A2 at where closer to the free end of the turning arm 3A. The square hole 3A3 is disposed at where in relation to an arc hole 16 penetrating through the top 11, and a handle 3D is inserted through the square hole 3A3 and the arc hole 16 to lock the turning arm 3A to the top 11 to control turning and positioning of the turning arm 3A for facilitating the adjustment of the cutting angle. A miter gage 17 of the same curve as that of the arc hole 16 is provided on the top 11 over the arc hole 16 for the angle adjustment by the turning arm 3A, and for turning the magnifier 3C provided on the surface 3A2 of the turning arm 3A to magnify the scales of the miter gage 17 to facilitate observation and measurement. The gear set is comprised of a large gear 3E, a medium gear 3F, and a small gear 3G in a specific gear ratio of 1:2. Wherein, the large gear 3E is provided at where the axial hole 15 is located below the top 11, and an axial hole 3E1 at the center of the large gear 3E and the shaft 3A1 of the turning arm 3A is inserted into the axial hole 3E1. A screw 3H adapted with a washer penetrates through the turning arm 3A, the axial hole 15 and the large gear 3E. The medium gear 3F and the small gear 3G are in sequence secured to where beneath the top 11 with a screw 1B with the small gear 3G located between the large gear 3E and the medium gear 3F to engage to one another to become a synchronous link subsystem. The medium gear 3F indicates a semi-circular shape and is connected on its side not provided with teeth to a rule 3F1 for a square 5 comprised of two rules at right angle to each other to flush against to directly calibrate the swinging angle of the turning arm 3A.

The circular saw 4 provided striding between the pair of guide rail 2A of the control unit 2 to reciprocally travel on the pair of guide rail 2A in smooth and reliable fashion to help upgrade sawing quality of the finished product of the board 4A. Furthermore, installation site on the table 1 for the circular saw 4 depending on its size can be adjusted in conjunction with the pair of guide rail 2A and two pairs of the connection blocks 2B to process the board 4A in different width and thickness.

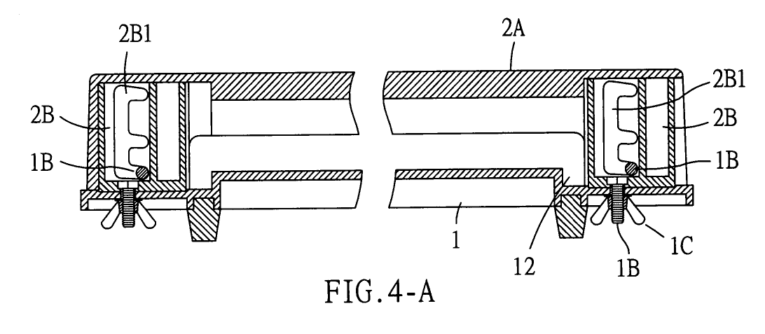

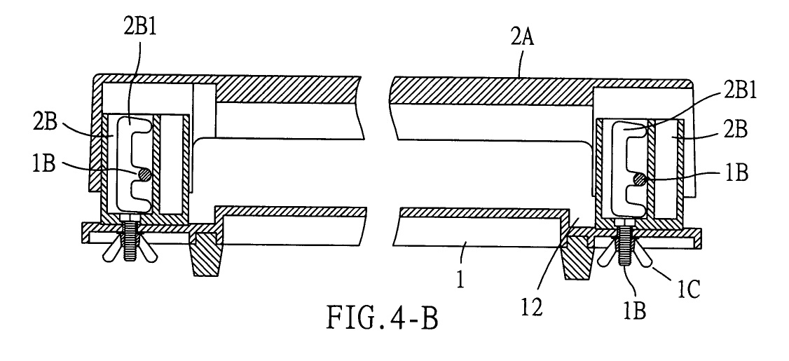

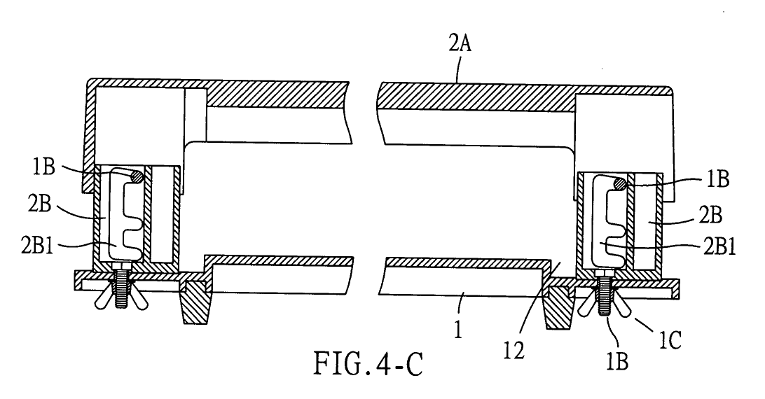

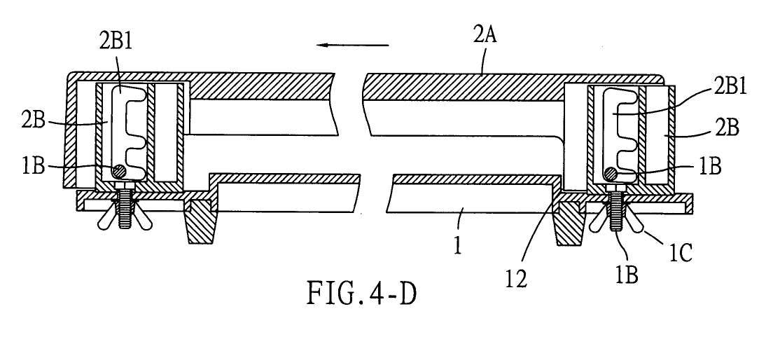

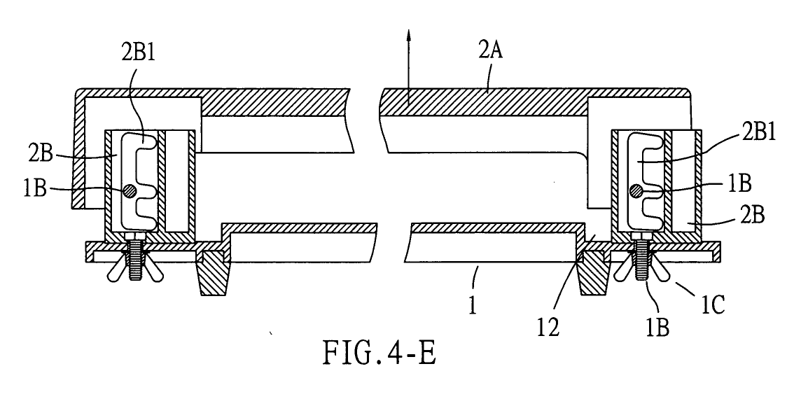

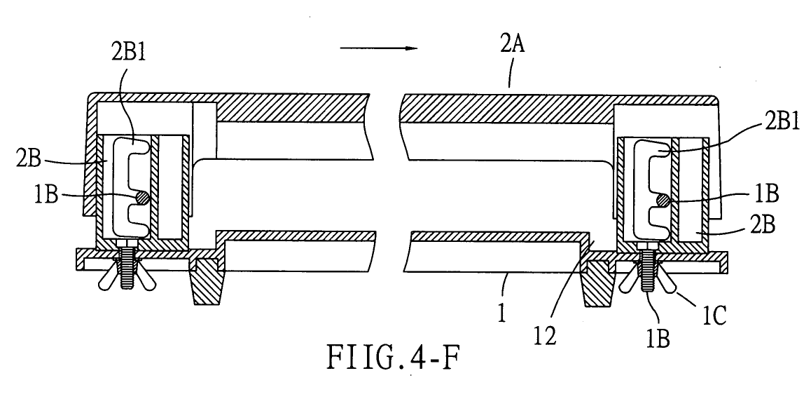

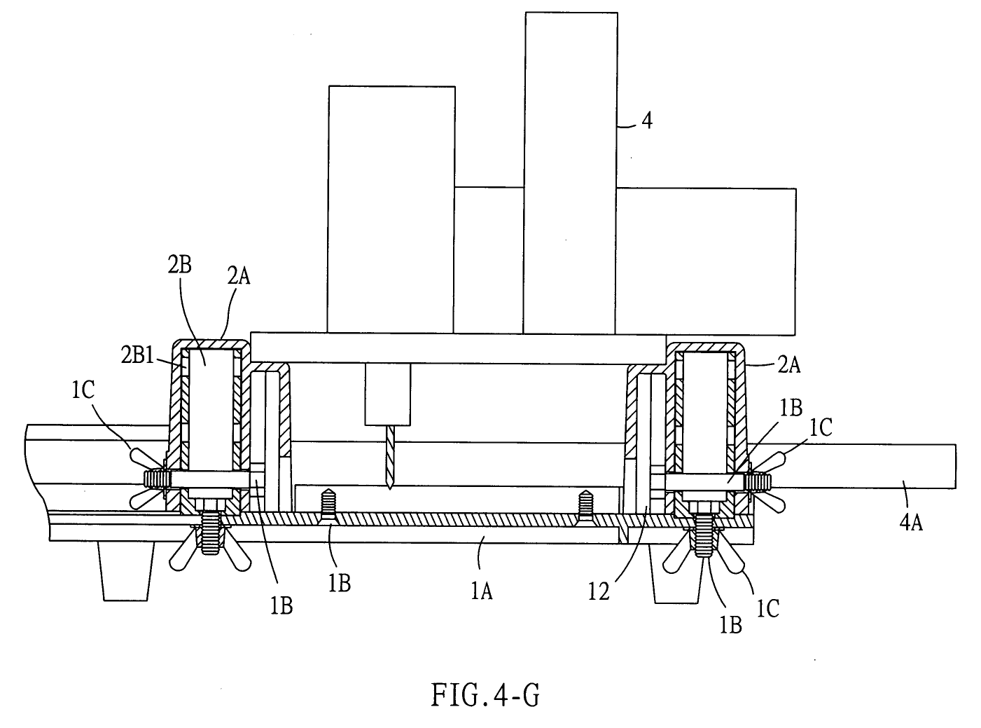

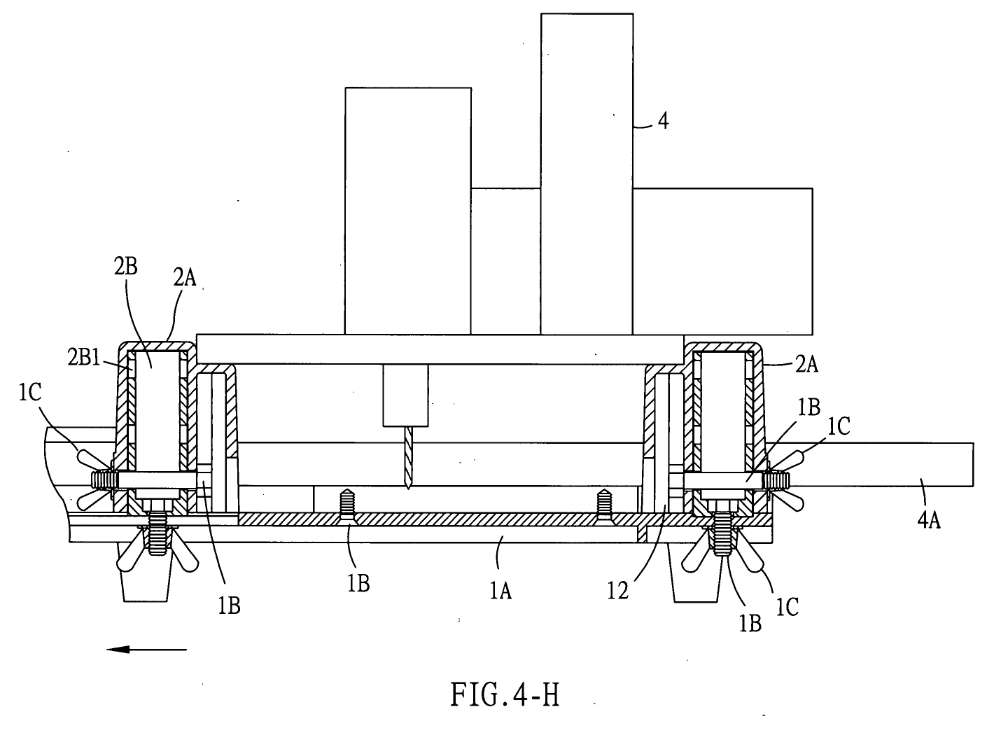

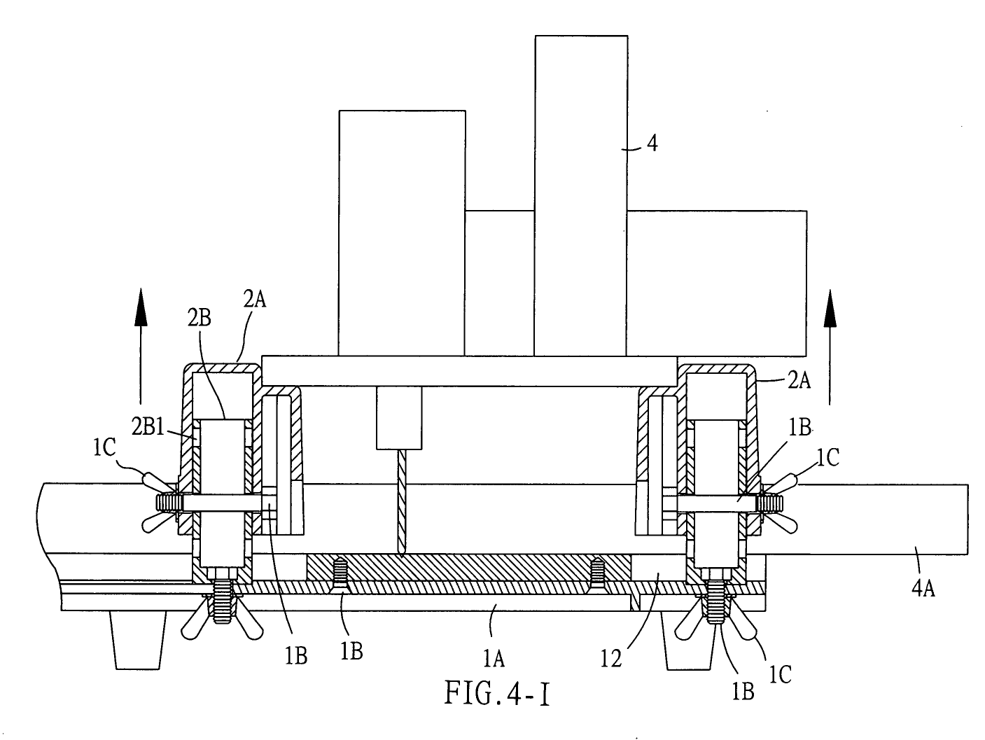

Now referring to FIGS. 4A, 4B, 4C, 4D, 4E, 4F, 4G, 4H, and 4I, wherein, both ends of each rail rise to be tightly caught in their respective chambers 2A1 upon adjusting the pair of guide rail 2A. Multiple screws 1B and winged nuts 1C secure each connection block 2B into each chamber 2A1 through the screw hole 2A2 and the multi-sectional adjustment channel 2B1. Accordingly, both guide rails 2A stride over and are locked to those two pairs of the connection blocks 2B. Whereas the guide rail slot 14 on the top 11 permits the pair of the connection blocks 2B to reciprocally travel in the guide rail slot 14 by fast loosening and retightening their respective screws 1B and winged nuts 1C, both guide rails 2A move synchronously to have the width between both guide rails 2A adjusted for compromising the specification of the circular saw 4 to be installed on the table 1 depending on the width and thickness of the board 4A placed on the top 11 for cutting.

By fast loosening and retightening those screws 1B and winged nuts 1C that lock up the pair of guide rail 2A to their respective connection blocks 2B, both pairs of the connection blocks 2B are adjusted to permit longitudinal movement of both ends of the pair of guide rails 2A for ascending or descending the circular saw 4 disposed between both guide rails 2A according to the specification of the circular saw 4 until it could handle the thickness of the board 4A. Accordingly, those screws 1B and winged nuts 1C are retightened to hold the circular saw 4 at a proper working height depending on the thickness of the board 4A to be placed on the top 11 for the circular saw 4 to cut.

The cutting angle of the board 4A is directly adjusted by the measurement unit 3 on the top 11 for the circular saw 4 to cut the board 4A into the preset angle. Manual measurement and solving the angle to mark the angle on the board 4A for the circular saw 4 to cut by following the mark as required in the prior art are no longer necessary.

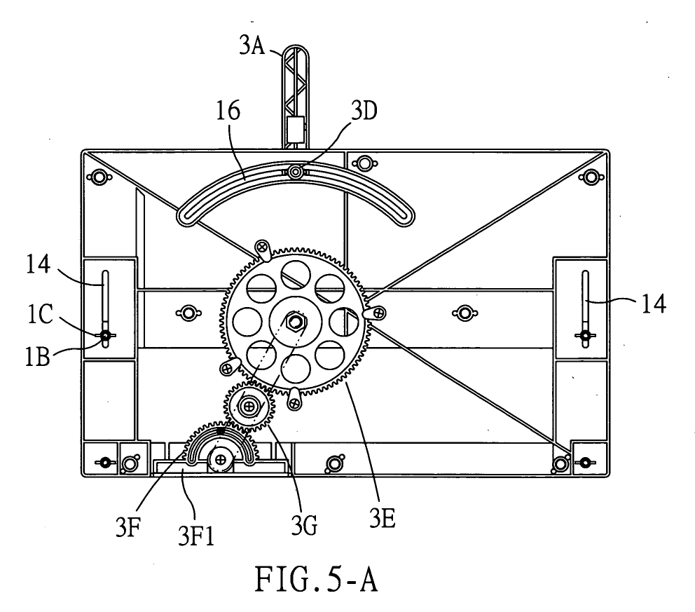

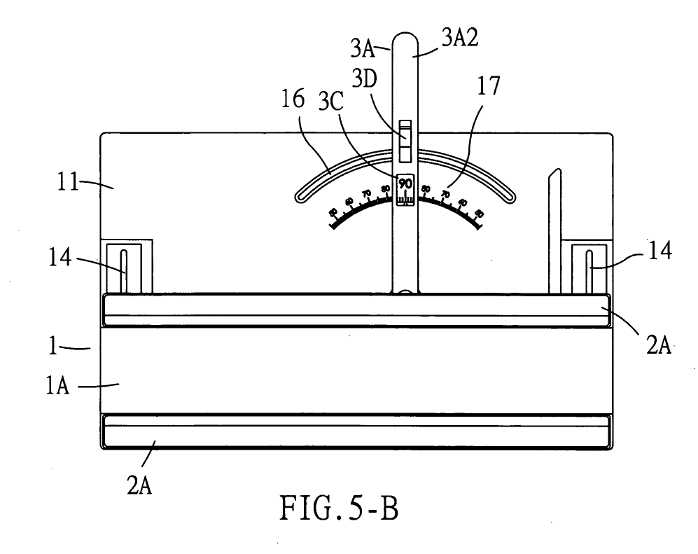

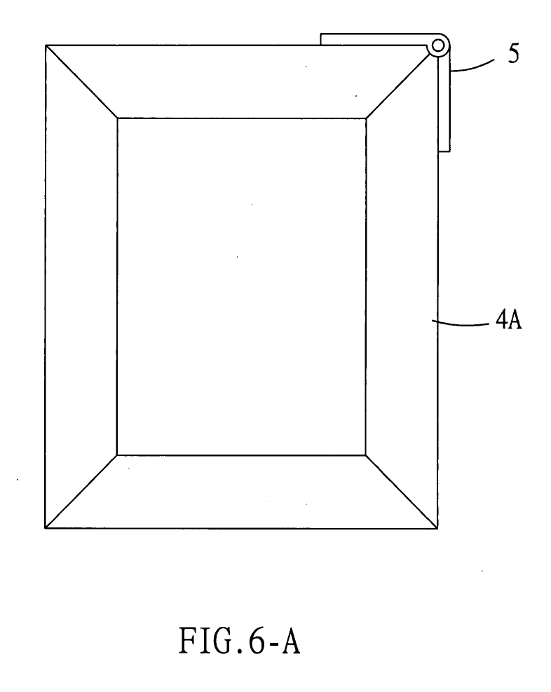

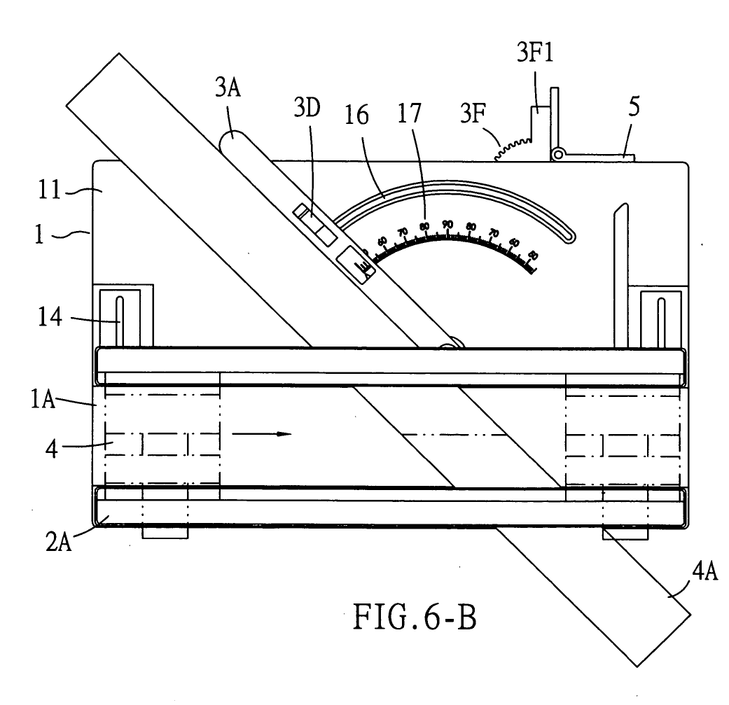

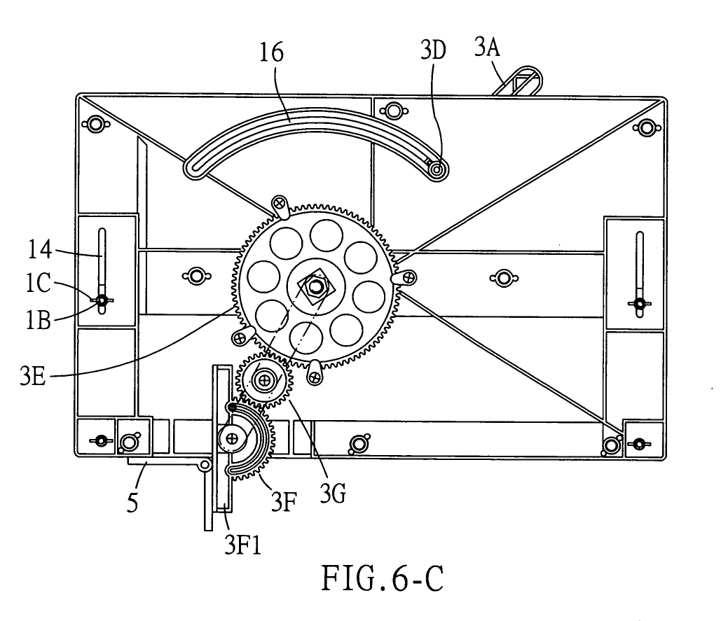

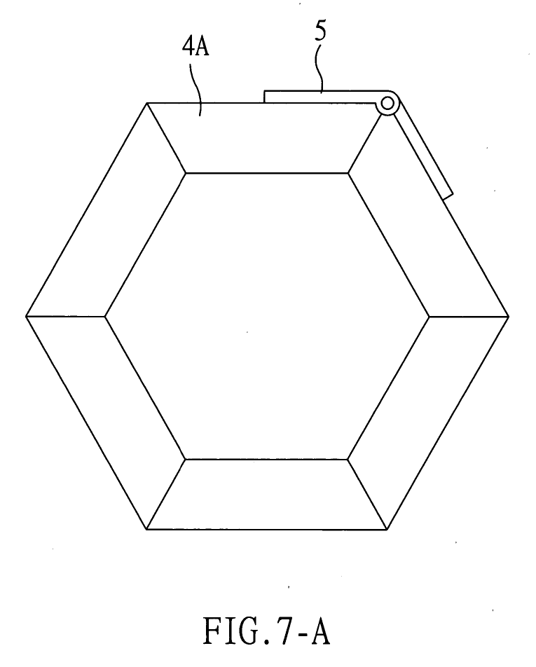

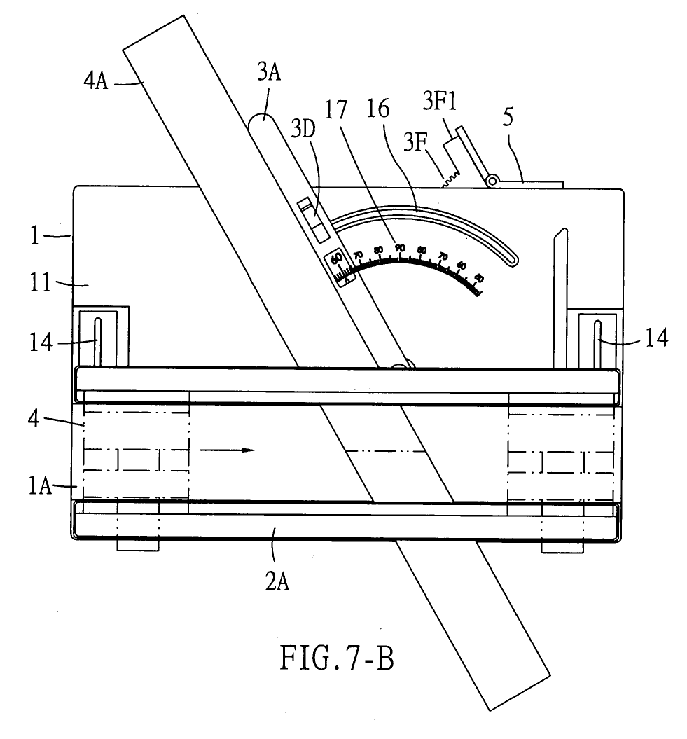

To make the measurement of the angle as illustrated in FIGS. 5A, 5B, 6A, 6B, 6C, 7A, and 7B, one rule of the square 5 is placed on the table 1, and the medium gear 3F is turned until its rule 3F1 is flushed against the other rule of the square 5. Whereas both of the small gear 3G and the large gear 3E are synchronously linked to the medium gear 3F, the turning arm 3A integrated with the large gear 3E with the screw 3H adapted with a washer is also turned to reach the preset angle. The turning arm 3A is secured in position at the preset angle by loosening and retightening the handle 3D pivoted through the square hole 3A3 on the turning arm 3A and the arc hole 16 on the top 11. The board 4A is placed on the top 11 to firmly flush against the turning arm 3A held in position at the preset angle. The circular saw 4 installed on the pair of the guide rails 2A then cuts the board 4A following the preset angle.

Alternatively, the magnifier 3C provided on the surface 3A2 of the turning arm 3A on the top 11 magnifies the miter gage 17 is used to observe the measurement. Once the turning arm 3A is turned to the location pinpointed by the miter gage 17, the handle 3D is loosened and retightened again to hold the turning arm 3A at the location of the miter gage 17 as observed, and the board 4A is placed on the top 11 until it is firmly flushed against the turning arm 3A for the circular saw 4 installed on the pair of the guide rails 2A to cut the board 4A at the preset angle.

Accordingly, the table 1 of the present invention cuts the board 4A without having to do the manual calculation of the geometric angle for the board 4A and avoids the possible inaccuracy in solving the preset angle simply by measuring the geometric angle with the square 5 and directly placing one rule of the square 5 on the table 1 and the other rule flushed against the rule 3F1 of the medium gear 3F to adjust the turning arm 3A to reach at the present angle for the circular saw 4 installed on the pair of the guide rails 2A to cut the board 4A at the preset angle.

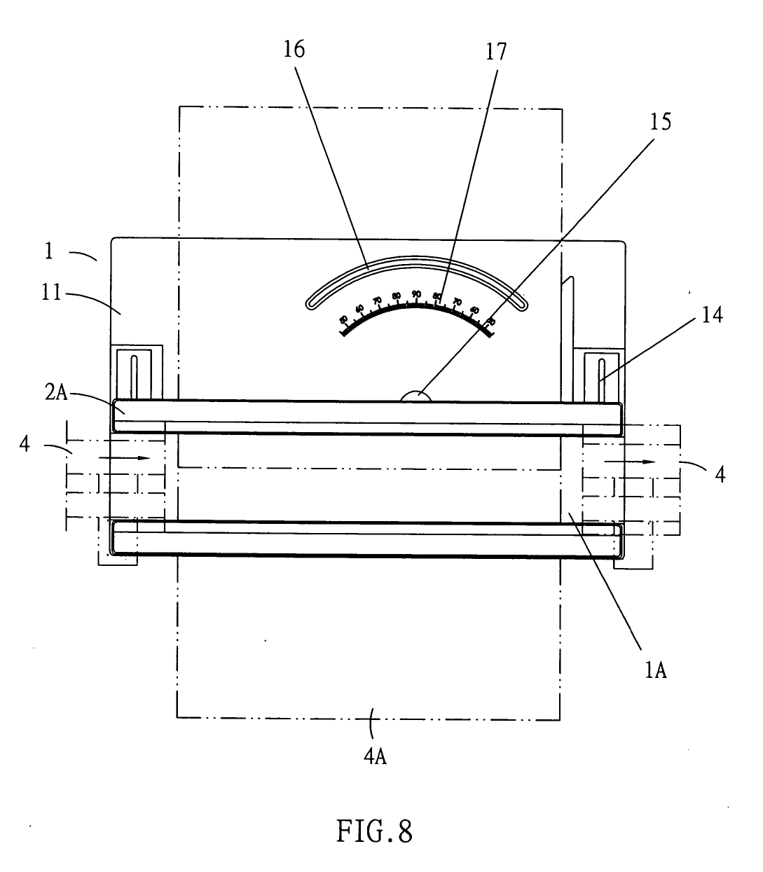

As illustrated in FIG. 8, the gear set of the present invention can be comprised of the large gear 3E, the medium gear 3F and a drive belt 3J at the gear ratio of 1:2. Wherein, the large gear 3E is placed at where the axial hole 15 is located beneath the top 11, and the axial hole 3E1 at the center of the large gear E is inserted by the shaft 3A1 of the turning arm 3A. The screw 3H adapted with a washer connects the turning arm 3A, the axial hole 15 and the large gear 3E into a one piece. The medium gear 3F is fixed to where beneath the top 11 with the screw 1B, and the drive belt 3J is inserted at where between the large gear 3E and the medium gear 3F to link both gears 3E, 3F for synchronous movement to have the turning arm 3A integrated with the large gear 3E by means of the screw 3H adapted with a washer to arrive at the preset angle. One upholding rod 3I is each provided on both sides of the drive belt 3J disposed between the large and the medium gears 3E, 3F. A head 3I1 of the upholding rod 31 merely contacts the outer edge of the driver belt 3J to prevent the drive belt 3J from falling off its place during the transmission of both the large and the medium gears 3E, 3F as driven by the drive belt 3J.

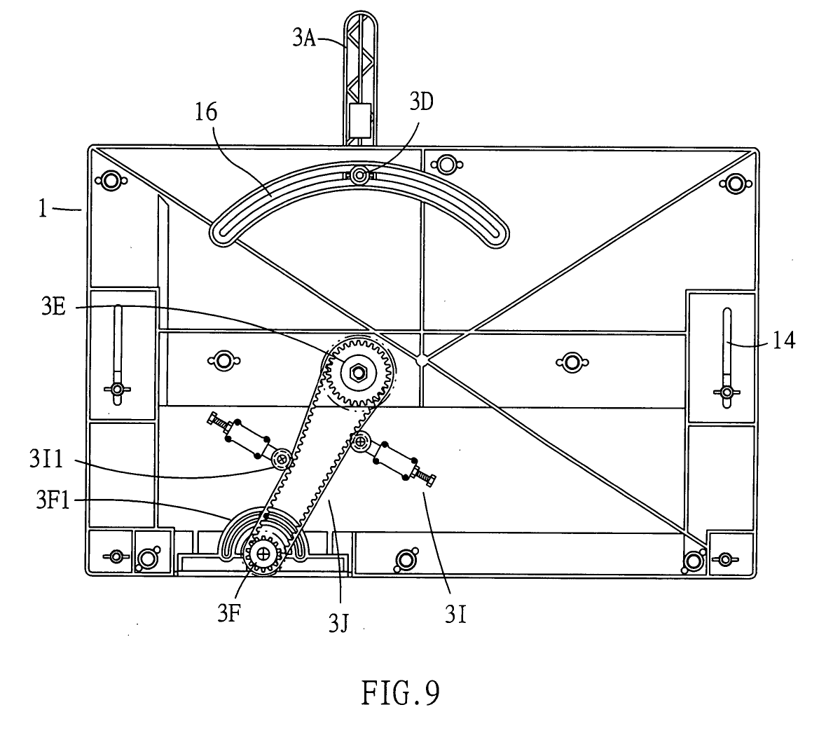

Furthermore, as illustrated in FIG. 9, the board 4A is placed at a right angle on the top 11 of the table 1, and the space on the top 11 is not sufficient for the placement of the board 4A due to the presence of the turning arm 3A of the measurement unit 3 on the top 11. The turning arm 3A of the measurement unit 3 on the top 11 is removed before placing the board 4A on the top 11 at a right angle.

It is to be noted that the preferred embodiments disclosed in the present invention are not used to limit the scope of the present invention, and that any equivalent change and decoration to the form, construction, characteristics and teaching described in the Claims of the present invention shall be deemed as falling within the scope of those Claims.

1. A carpenter saw table with angle adjustable essentially comprised of a control unit and a measurement unit;
the control unit on one side of a top of the table comprised of a pair of guide rails and two pairs of connection blocks; one pair of the connection blocks being raised and locked to a positioning hole each disposed on both ends on one side of the top with multiple screws and winged nuts; another pair of the connection blocks being raised and locked with multiple screws and winged nuts to a guide rail slot disposed on the inner side of the top, and reciprocally traveling along the guide rail slot by fast loosening the winged nuts; both guide rails being installed to stride over the top by means of those two pairs of the connection blocks; a chamber being provided to both ends of each guide rail; and each connection block being upwardly and tightly received in its respective chamber; both sides of the chamber and the connection block being hollowed with screw holes and E shaped multi-sectional adjustment channel to facilitate the fast loosening and retightening of the screws and the winged nuts; both ends of each guide rail, and thus the circular saw, longitudinally moving in relation to their respective connection blocks by compromising the specification of the individual circular saw; and
the measurement unit comprised of a turning arm and a gear set; a shaft extending from the bottom of the fixed end of the turning arm and penetrating downwardly through the axial hole on the top to be pivoted to the gear set provided beneath the top; a square hole being disposed on the turning arm at where close to the free end of the turning arm in relation to an arc hole penetrating through the top; a handle being pivoted through the square hole and the arc hole on the top to control the turning arm and positioning of the turning arm for angle adjustment; a miter gage of the same curve with that of the arc hole being provided on the top above the arc hole to adjust the angle of the turning arm; the gear set comprised of a large gear, a medium gear, and a small gear at the gear ratio of 1:2, the large gear being secured in the axial hole beneath the top; an axial hole at the center of the large gear being inserted by the shaft extending from the turning arm, and being integrated with the turning arm and the axial hole beneath the top by means of a screw adapted with a washer; the medium gear and the small gear being sequence screwed to where beneath the top; the small gear being provided and engaged between and to the large and the medium gears; and the large, the medium, and the small gears becoming a synchronous link.

2. The carpenter saw table with angle adjustable of claim 1, wherein, a magnifier is provided on the turning arm to magnify the miter gage for observation and measurement.

3. The carpenter saw table with angle adjustable of claim 1, wherein, the medium gear indicates a semi-circular shape with the side not provided with gear tooth indicating a flat for the placement of a rule that extends from the gear; and a square for angle measurement being flushed against the flat to directly calibrate the swinging angle of the turning arm.

4. The carpenter saw table with angle adjustable of claim 1, wherein, the gear set is comprised of the large gear, the medium gear at a gear ratio of 1:2, and a drive belt; the large gear being provided in the axial hole beneath the top of the table; both of the large and the medium gears being linked by means of the drive belt disposed between both of the large and the medium gears; the turning arm integrated with the large gear by means of a screw adapted with a washer to reach the location of the preset angle; an upholding rod being each provided on both sides of the drive belt disposed between the large and the medium gears; and an upholding rod being each provided on both sides of the drive belt disposed between the large and the medium gears with a head of the upholding rod merely contacting the outer edge of the driver belt to prevent it from falling off its place.
